(19) United States
(12) Patent Application Publication
(10) Pub. No.: US 2026/0148109 A1
(43) Pub. Date: May 28, 2026

(54) METHODS AND SYSTEMS FOR BUILDING LEARNING DATA FOR ARTIFICIAL INTELLIGENCE MODELS

(71) Applicant: NAVER CORPORATION, Seongnam-si (KR)

(72) Inventors: Sang Jin SIM, Seongnam-si (KR); Jae Hun SHIN, Seongnam-si (KR); Hyoung Dong HAN, Seongnam-si (KR); Se Jong KIM, Seongnam-si (KR); Seung Hak YU, Seongnam-si (KR); Young-Bum KIM, Seongnam-si (KR)

(73) Assignee: NAVER CORPORATION, Seongnam-si (KR)

(21) Appl. No.: 19/400,269

(22) Filed: Nov. 25, 2025

(30) Foreign Application Priority Data
Nov. 25, 2024 (KR) 10-2024-0170133

(51) Int. Cl. G06N 5/04

(52) U.S. Cl. CPC G06N 5/04

(57) ABSTRACT

A method for building training data for artificial intelligence models may include collecting a plurality of user inputs input to a generative AI search system, collecting a plurality of inference results for agent invocation from an AI model that processes each of the plurality of user inputs, each among the plurality of inference results corresponding to one among the plurality of user inputs, determining a respective suitability of each among the plurality of inference results using at least some among the plurality of user inputs to obtain suitability determination results, and specifying a respective group type of each among a plurality of input groups using the suitability determination results, each among the plurality of input groups including at least some among the plurality of user inputs.

### CROSS REFERENCE TO RELATED APPLICATION

The present application claims priority to Korean Patent Application No. 10-2024-0170133, filed Nov. 25, 2024, the entire contents of which are hereby incorporated by reference in their entirety.

### BACKGROUND

### Technical Field

The present disclosure relates to a method and system for building learning or training data for artificial intelligence models.

### Description of the Related Art

The dictionary definition of Artificial Intelligence (AI) is a technology that realizes human abilities, such as learning ability, reasoning ability, perceptual ability, and natural language understanding, through computer programs. AI has achieved remarkable advancements due to deep learning.

In particular, thanks to the advancement of AI, various language models have been developed. The language models have reached a level at which they not only recognize text and understand its meaning, but also extract information from vast amounts of text data, such as documents, classify the extracted information, and furthermore generate text directly.

The language models are actively utilized in various fields, and may be performed based on text, such as search engines, document writing (e.g., resume writing, report writing, post writing, etc.), free conversation on diverse topics, data parsing (e.g., data summarization, classification, etc.) from given texts, expert knowledge provision, programming, and transforming given sentences into appropriate styles that exist in numerous fields. In addition, a method may be performed for generating marketing phrases for a target to be advertised using a language model.

Furthermore, the language models extend beyond a keyword-based search engine and are utilized in generative AI search services that perform searches according to a user intent expressed in natural language and provide results of such searches as answers.

With the emergence of such generative AI search services, various studies are being conducted to ensure or improve the quality of tasks for services. For example, AI models are trained to generate results selected by a user and avoid generating results that the user does not select (or reduce such results), thereby deriving outcomes that correspond to the user preference. However, this method requires (or otherwise, uses) data having records of user preferences, and inevitably reflects human bias during the process of building preference data.

### SUMMARY

The present disclosure is directed to providing a method and system for building training data to improve a generative artificial intelligence search system. A method is provided for improving generative search systems by minimizing (or reducing) human intervention and relying on objective evaluation.

More specifically, the present disclosure is directed to providing a method and system for defining, as defects, cases where results of a generative artificial intelligence search system are not suitable for achieving the goal and building training data to reduce such defects.

In addition, the present disclosure is directed to providing a method and system for building training data for artificial intelligence models capable of evaluating an improved generative artificial intelligence search system to verify the reliability of the models.

In order to address the above-described challenge, according to the present disclosure, a method and system for building training data for artificial intelligence models may include collecting a plurality of user inputs input to a generative AI search system, collecting a plurality of inference results for agent invocation from an AI model that processes each of the plurality of user inputs, each among the plurality of inference results corresponding to one among the plurality of user inputs, determining a respective suitability of each among the plurality of inference results using at least some among the plurality of user inputs to obtain suitability determination results, and specifying a respective group type of each among a plurality of input groups using the suitability determination results, each among the plurality of input groups including at least some among the plurality of user inputs.

Further, according to the present disclosure, a system for building training data for artificial intelligence models includes a memory storing computer-readable instructions, and at least one processor configured to execute the computer-readable instructions to cause the system to collect a plurality of user inputs input to a generative AI search system, collect a plurality of inference results for agent invocation from an AI model configured to process each of the plurality of user inputs, each among the plurality of inference results corresponding to one among the plurality of user inputs, determine a respective suitability of each among the plurality of inference results using at least some among the plurality of user inputs to obtain suitability determination results, and specify a respective group type of each among a plurality of input groups using the suitability determination results, each among the plurality of input groups including at least some among the plurality of user inputs.

Further, according to the present disclosure, a program stored on a non-transitory computer-readable medium and executed by one or more processors on an electronic device, in which the program may include instructions to perform collecting a plurality of user inputs input to a generative AI search system, collecting a plurality of inference results for agent invocation corresponding to each of the plurality of user inputs from an AI model that processes each of the plurality of user inputs, determining suitability of each of the inference results using at least some of the plurality of user inputs, and specifying group types of the plurality of input groups, each of which includes at least some of the plurality of user inputs, using suitability determination results for each of the plurality of inference results.

In addition, according to the present disclosure, a method for building training data for Artificial Intelligence (AI) models may include collecting a plurality of performance results output from an agent of a generative AI search system, collecting a plurality of first inference results from a first AI model that processes each of the plurality of performance results, each among the plurality of first inference results corresponding to one among the plurality of performance results, and the first AI model being among the AI models, determining a respective suitability of each among the plurality of first inference results using at least some among the plurality of performance results to obtain suitability determination results, and specifying a respective group type of each among a plurality of performance result groups using the suitability determination results, each among the plurality of performance result groups including at least some among the plurality of performance results.

According to a method and system for building training data based on Artificial Intelligence (AI) of the present disclosure, by collecting a plurality of user inputs input to a generative AI search system and a plurality of inference results corresponding to each of the plurality of user inputs for agent invocation, it is possible to improve the generative AI search system.

More specifically, according to the method and system for building training data based on artificial intelligence of the present disclosure, it is possible to determine the suitability of each inference result using at least some of the plurality of user inputs and specify group types of each of the plurality of input groups using suitability determination results for each of the plurality of inference results. As a result, according to the present disclosure, it is possible to build the training data for improving the generative AI search system. In particular, the present disclosure may enhance objectivity by minimizing (or reducing) human intervention and may be applied even in environments where fine-tuning of agents is difficult.

### BRIEF DESCRIPTION OF THE DRAWINGS

FIG. 1 is a conceptual diagram for describing a generative search system according to the present disclosure.

FIG. 2 is a conceptual diagram for describing a system for building training data for Artificial Intelligence (AI) models according to the present disclosure.

FIG. 3 is a flowchart for describing the method for building training data for AI models according to the present disclosure.

FIGS. 4, 5A to 5C, 6, and 7 are conceptual diagrams for describing a method for building training data for a first AI model using an inference result for agent invocation.

FIGS. 8A and 8B are conceptual diagrams for describing verification of an improved first AI model.

FIGS. 9, 10A to 10C, 11, and 12 are conceptual diagrams for describing a method for building training data for a second artificial intelligence model using agent performance results.

FIGS. 13A and 13B are conceptual diagrams for describing verification of an improved second AI model.

### DETAILED DESCRIPTION

Hereafter, some example embodiments disclosed in the present specification will be described in detail with reference to the accompanying drawings and the same or similar components are given the same (or similar) reference numerals regardless of the reference numbers of figures and are not repeatedly described. In addition, terms “module” and “unit” for components used in the following description are used only to easily make the disclosure. Therefore, these terms do not have meanings or roles that distinguish from each other in themselves. Further, when it is determined that a detailed description for the related known art in describing some example embodiments disclosed in the present specification may obscure the gist of the present disclosure, a detailed description thereof will be omitted. Further, it should be understood that the accompanying drawings are provided only in order to allow some example embodiments disclosed in the present specification to be easily understood, and the spirit of the present disclosure is not limited by the accompanying drawings, but includes all the modifications, equivalents, and substitutions included in the spirit and the scope of the present disclosure.

Terms including ordinal numbers such as “first”, “second”, etc., may be used to describe various components, but the components are not to be construed as being limited to the terms. The terms are used to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element interposed therebetween.

Singular expressions are intended to include plural expressions unless the context clearly represents otherwise.

It will be further understood that terms “include”, “have”, or the like used in the present specification specify the presence of features, numerals, operations, components, parts mentioned in the present specification, or combinations thereof, but do not preclude the presence or addition of one or more other features, numerals, operations, components, parts, or combinations thereof.

The present disclosure provides a method and system for building training data to improve a generative Artificial Intelligence (AI) search system when results of the generative AI search system are not suitable for achieving a goal.

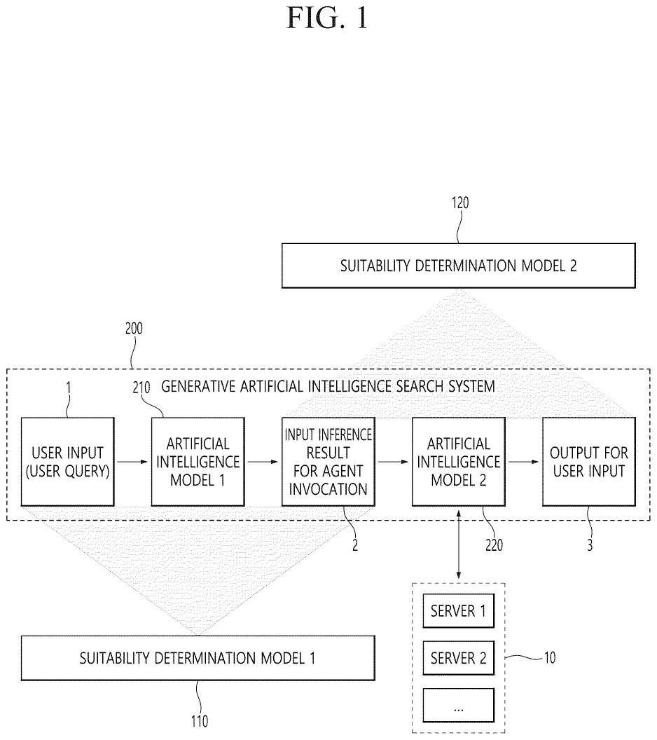

FIG. 1 is a conceptual diagram for describing a generative AI search system according to the present disclosure. As illustrated in FIG. 1, the present disclosure relates to a method and system for building training data for improving a generative AI search system 200 by determining the suitability of the generative AI search system 200.

The generative AI search system 200 may perform a search on an external server 10 (e.g., search engine) to provide an answer to a user input 1 (or user query) using a generative AI model, and use the search results to provide an answer 3 to a user.

In order to achieve the user's goal, the generative AI search system 200 may generate an inference result 2 (e.g., text, image, sound, parameter, vector representation, etc.) for agent invocation by performing inference of a generative AI model 210 (hereinafter, referred to as a “first AI model”) on a user input 1 (e.g., text, image, sound, etc.), and process the performance results (e.g., text, image, sound, vector representation, etc.) of the invoked agent through an inference process of a generative AI model 220 (hereinafter, referred to as a “second AI model”), thereby generating an output 3 (e.g., text, image, sound, etc.) for the user input.

In the present disclosure, it may be determined whether the results generated during the operation of the generative AI search system 200 are suitable using suitability determination models (a first suitability determination model 110 and a second suitability determination model 120) corresponding to each operation. More specifically, the present disclosure may use the first suitability determination model 110 to determine whether the results generated by the first AI model 210 are suitable for achieving the goal of the first AI model 210, and use the second suitability determination model 120 to determine whether the results generated by the second AI model 220 are suitable for achieving the goal of the second AI model 220. According to some example embodiments, operations described herein as being performed by the generative AI search system 200, the external server 10, the first suitability determination model 110 and/or the second suitability determination model 120 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a Central Processing Unit (CPU), an Arithmetic Logic Unit (ALU), a Graphics Processing Unit (GPU), a digital signal processor, a microcomputer, a Field Programmable Gate Array (FPGA), a System-on-Chip (SoC), a programmable logic unit, a microprocessor, Application-Specific Integrated Circuit (ASIC), etc.

According to some example embodiments, the processing circuitry may perform some operations (e.g., the operations described herein as being performed by the generative AI model 210, the generative AI model 220, etc.) by artificial intelligence and/or machine learning. As an example, the processing circuitry may implement an artificial neural network (e.g., the generative AI model 210, the generative AI model 220, etc.) that is trained on a set of training data by, for example, a supervised, unsupervised, and/or reinforcement learning model, and wherein the processing circuitry may process a feature vector to provide output based upon the training. Such artificial neural networks may utilize a variety of artificial neural network organizational and processing models, such as Convolutional Neural Networks (CNN), Recurrent Neural Networks (RNN) optionally including Long Short-Term Memory (LSTM) units and/or Gated Recurrent Units (GRU), Stacking-based Deep Neural Networks (S-DNN), State-Space Dynamic Neural Networks (S-SDNN), deconvolution networks, Deep Belief Networks (DBN), and/or Restricted Boltzmann Machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

Herein, a machine learning model may have any structure that is trainable, e.g., with training data. For example, the machine learning model may include an artificial neural network, a decision tree, a support vector machine, a Bayesian network, a genetic algorithm, and/or the like. The machine learning model will now be described by mainly referring to an artificial neural network, but some example embodiments are not limited thereto. Non-limiting examples of the artificial neural network may include a Convolution Neural Network (CNN), a Region based Convolution Neural Network (R-CNN), a Region Proposal Network (RPN), a Recurrent Neural Network (RNN), a Stacking-based Deep Neural Network (S-DNN), a State-Space Dynamic Neural Network (S-SDNN), a deconvolution network, a Deep Belief Network (DBN), a Restricted Boltzmann Machine (RBM), a fully convolutional network, a Long Short-Term Memory (LSTM) network, a classification network, and/or the like.

In the present disclosure, in the generative AI search system 200, for achieving the goal corresponding to the user input 1, a case where the results generated by any one of the first AI model 210 or the second AI model 220 are not suitable for achieving the user's intended goal may be defined as a “defect.” In order to improve (e.g., address, reduce, eliminate, etc.) the corresponding defect, the present disclosure may build improved training data for the generative AI search system 200 by simulating a distribution of results, which are determined as suitable for achieving the goal, among the results generated by the generative AI search system 200.

For convenience of description, the present disclosure describes that the generative AI search system 200 includes the first AI model 210 and the second AI model 220. However, the generative AI search system 200 may include two or more different AI models (or models performing detailed functions), and the present disclosure may be configured to build training data for at least one of the plurality of AI models.

For example, the generative AI search system 200 may include any one of i) a search intent identification model that determines the necessity of a search (or whether a search should be performed) based on the user input intent and, if the search is necessary (or should be performed), determines which domain search engine to use; ii) a search query generation model that generates at least one of a search query, an image, and/or a vector representation for a search using the generative AI search model for the user input; iii) a search execution model that secures search results associated with the user input through the search engine based on at least one of the search query, image, and/or vector representation generated for the search, iv) an information verification model that determines the relevance of the user input based on the secured search results to specify search results above a certain criterion, and/or v) an answer generation model that generates an answer to the user input based on the specified search results. In addition, the present disclosure may build training data by determining the suitability of at least one of the above-described i) search intent identification model, ii) search query generation model, iii) search execution model, iv) information verification model, and/or v) answer generation model.

Furthermore, the present disclosure is not limited to improving the generative AI search system 200. The present disclosure may be used for building the training data to improve the AI model-based system, regardless of the functions of the corresponding system or the services provided by the corresponding system.

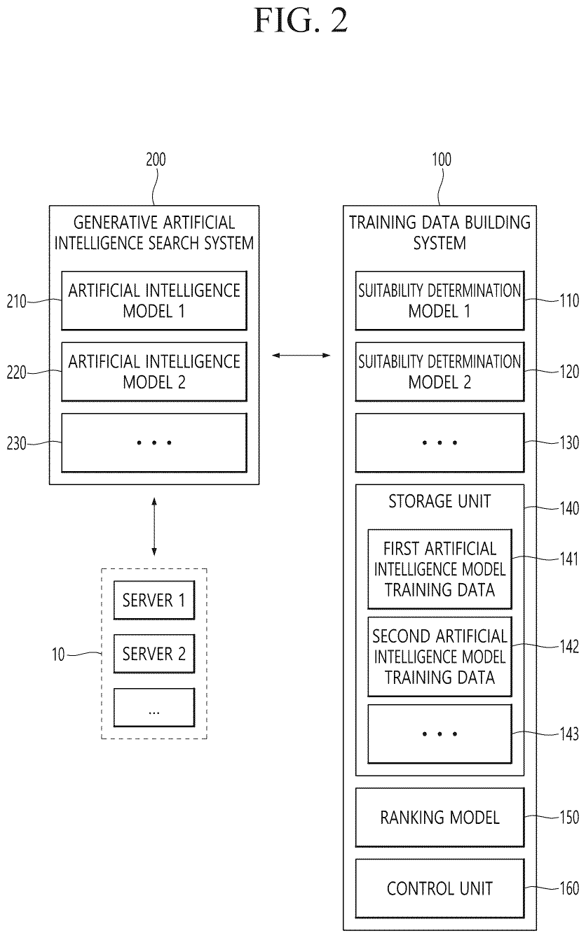

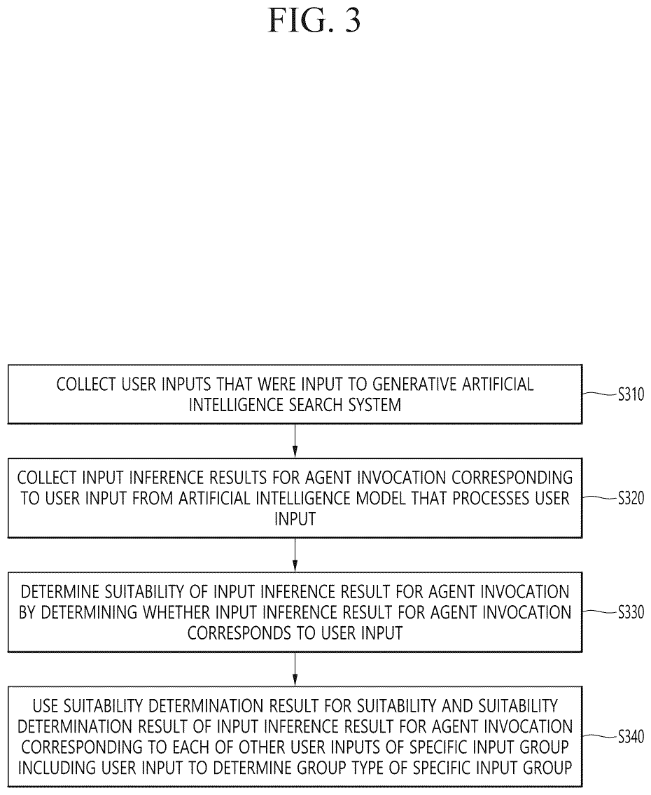

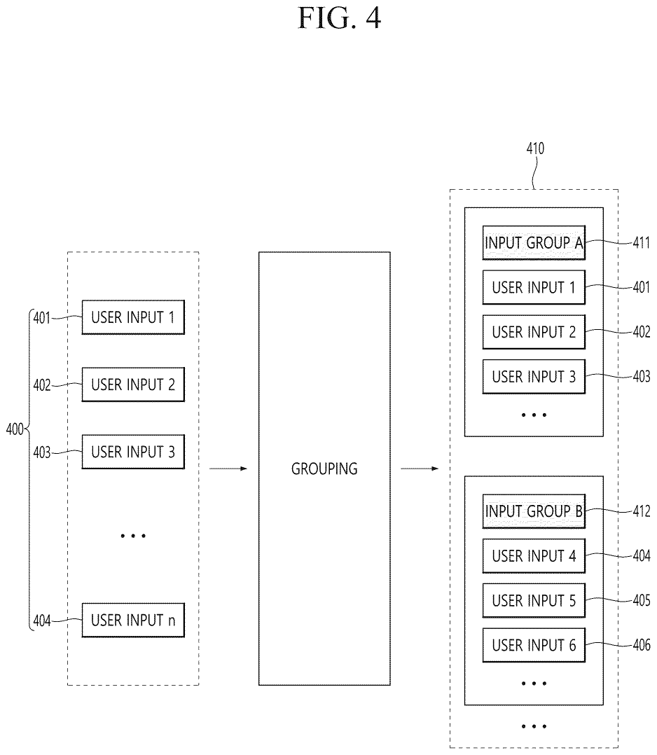

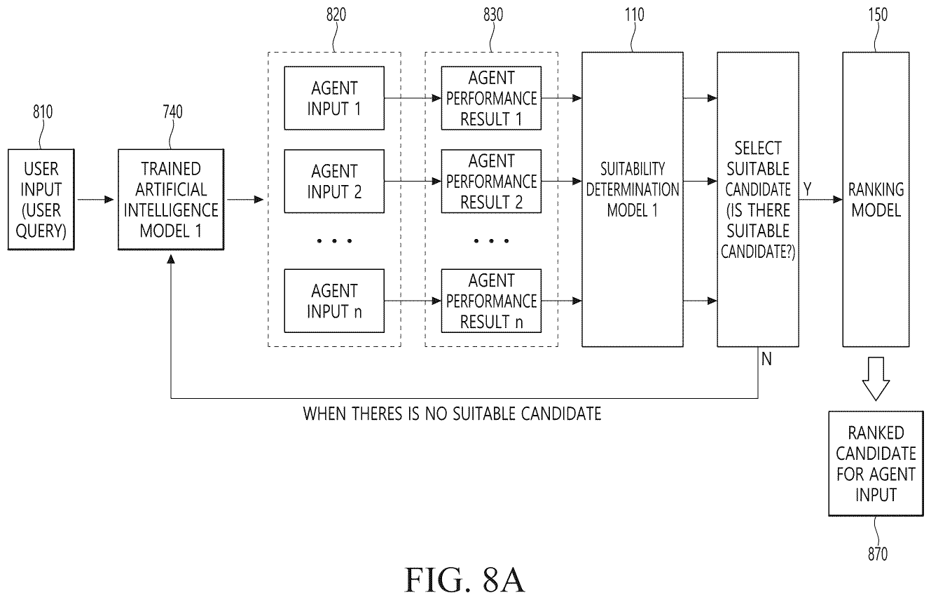

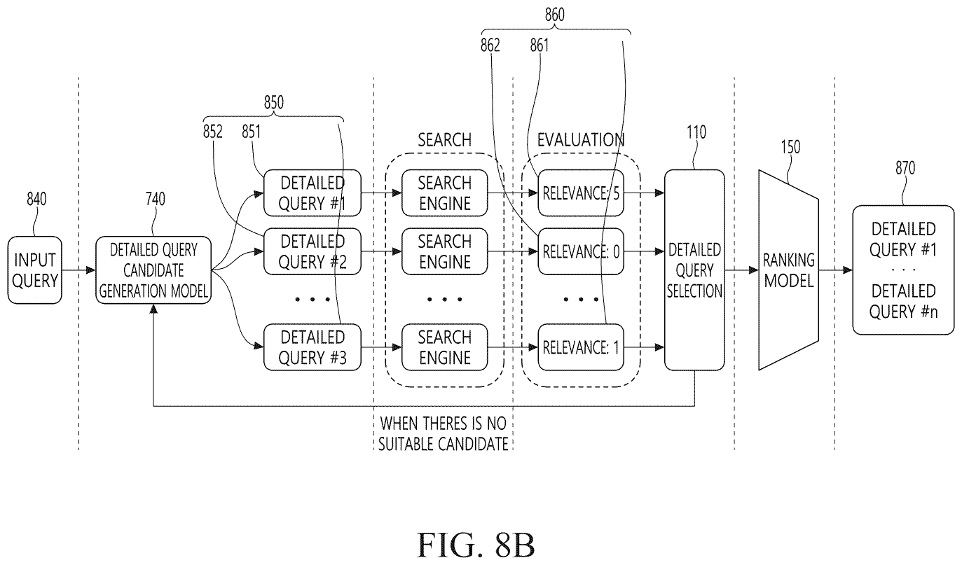

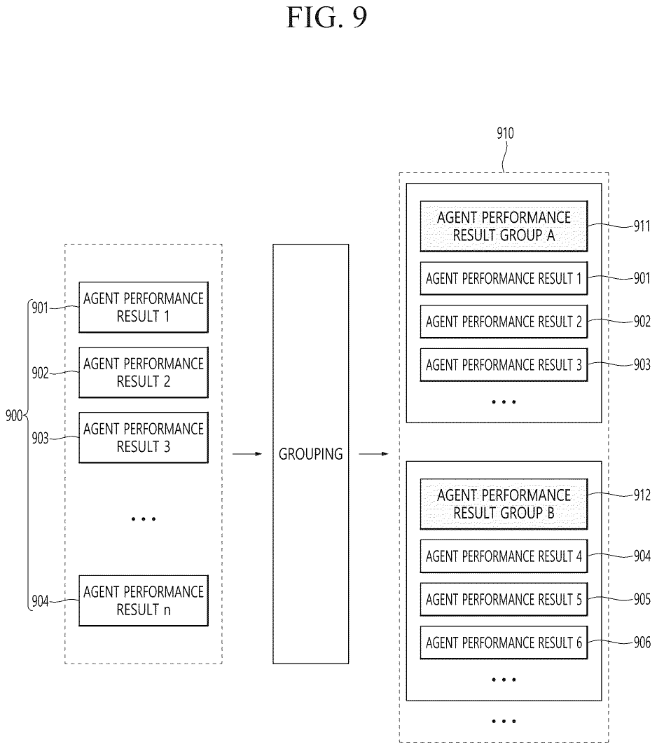

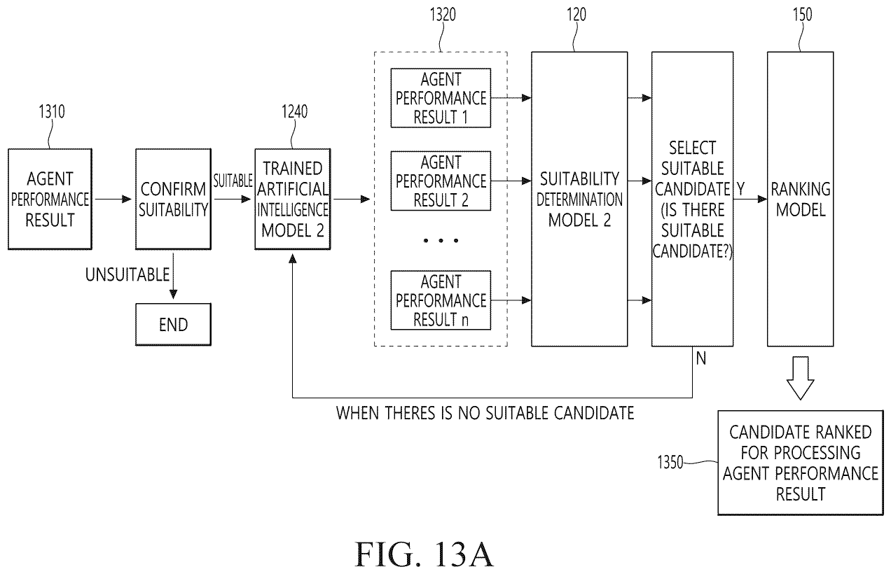

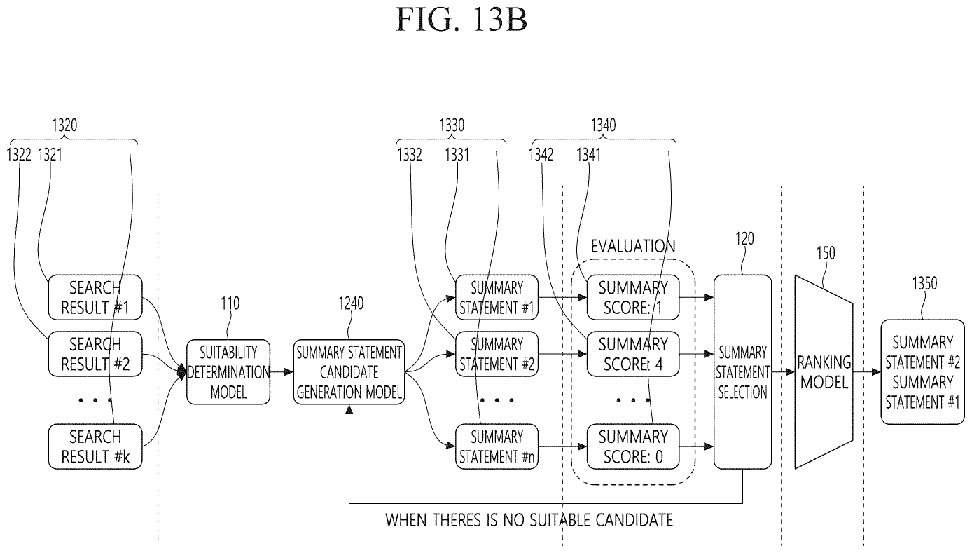

Hereinafter, a method for building training data for a generative AI search system will be described in detail with the attached drawings as an example. FIG. 2 is a conceptual diagram for describing a system for building training data for AI models according to the present disclosure. FIG. 3 is a flowchart for describing the method for building training data for AI models according to the present disclosure, and FIGS. 4, 5A to 5C, 6, and 7 are conceptual diagrams for describing a method for building training data for a first AI model using an inference result for agent invocation. FIGS. 8A and 8B are conceptual diagrams for describing verification of an improved first AI model, FIGS. 9, 10A to 10C, 11, and 12 are conceptual diagrams for describing a method for building training data for a second artificial intelligence model using agent performance results, and FIGS. 13A and 13B are conceptual diagrams for describing verification of an improved second AI model.

As illustrated in FIG. 2, the system 100 for building training data for AI models (hereinafter, “training data building system”) according to the present disclosure may include at least one of suitability determination models 110 to 130, a storage unit 140, a ranking model 150, and/or at least one control unit 160. According to some example embodiments, the training data building system 100, each among the suitability determination models 110 to 130, the ranking model 150 and/or each among the at least one control unit 160 may be implemented using processing circuitry. According to some example embodiments, the training data building system 100 may include a memory storing computer-readable instructions and at least one processor configured to execute the computer-readable instructions to cause the training data building system 100 to perform the operations described herein.

The suitability determination models 110 to 130 may be configured to determine whether each of the AI models 210 to 230 of the generative AI search system 200 is suitable.

In some example embodiments, the suitability determination models may further include algorithmic logic configured to evaluate the alignment between the inference result and the user intent at a more granular level. For instance, when implemented as a Large Language Model (LLM), the suitability determination model may generate latent semantic embeddings for the user input, the inference result, and the agent performance result, and compute an intent-similarity score using a cosine similarity or distance metric. When implemented as a rule-based model, the suitability determination model may apply deterministic rules including keyword-presence validation, domain-specific constraints, or template-matching. When implemented as a statistical-based model, the suitability determination model may compute probabilistic relevance features such as semantic-coverage probability, entity-matching probability, or omission probability, and determine suitability using logistic regression, Bayesian classification, or distance-based scoring.

As described above, the generative AI search system 200 includes at least one AI model. The present disclosure may describe, by way of example, the system that includes the first AI model 210 generating an input for agent invocation for a user input, and the second AI model 220 generating an output (or answer) for the user input using agent performance results. However, the generative AI search system 200 may further include the Nth AI model 230 (N may be an integer having a value of two or greater). According to some example embodiments, the processing circuitry may perform some operations (e.g., the operations described herein as being performed by each among the AI models 210 to 230) by artificial intelligence and/or machine learning. As an example, the processing circuitry may implement an artificial neural network (e.g., each among the AI models 210 to 230) that is trained on a set of training data by, for example, a supervised, unsupervised, and/or reinforcement learning model, and wherein the processing circuitry may process a feature vector to provide output based upon the training.

The suitability determination models 110 to 130 may include the first suitability determination model 110 for determining the suitability of the first AI model 210, the second suitability determination model 120 for determining the suitability of the second AI model 220, and the Nth suitability determination model 130 for determining the suitability of the Nth AI model 230.

The plurality of suitability determination models 110 to 130 may determine whether the AI model is suitable based on at least one of a Large Language Model (LLM), a rule-based model, and/or a statistical-based model.

Furthermore, the plurality of suitability determination models 110 to 130 may be composed of one suitability determination model. In this case, one suitability determination model may selectively use at least one of a Large Language Model (LLM), a rule-based model, and/or a statistical-based model to determine the suitability of the corresponding AI model, depending on which AI model is subject to the suitability determination. That is, in the present disclosure, the plurality of suitability determination models 110 to 130 may be conceptually distinct concepts, but are not necessarily physically distinct.

The plurality of suitability determination models 110 to 130 may determine the suitability of the AI models 210 to 230 to be determined based on whether the results of the AI models 210 to 230 to be determined align with the goal of the AI model.

In the present disclosure, the result of the AI model to be determined that does not align with the goal of the corresponding model is defined as a ‘defect’. Each of the plurality of suitability determination models 110 to 130 may be understood as determining whether the AI models 210 to 230 to be determined are defective.

In the inventive concepts, a defect refers to the generative AI search system 200 producing incorrect results or failing to function as intended during operation. The defect may vary, such as misinterpreting the meaning of input data, providing irrelevant data, or omitting necessary (or otherwise, appropriate or significant) data.

The defect may be understood as the defect of the output data generated by each AI model with respect to the input data input to each AI model. In addition, the type of defects occurring in each of the plurality of AI models may be different from each other.

For example, the defect in the search intent identification model occurs when the search intent identification model fails to correctly interpret a user query and occurs when an incorrect intent is identified. For example, when a user queries “Cheer of Police,” if the search intent identification model misinterprets the user input intent as contents associated with support (or rooting) for the police rather than police ranks and generates output data, this may be considered a defect (assuming the user's actual search intent is “Chief of Police”).

The defect in the search model occurs when the search model fails to secure correct search results based on a search query. It may be determined that the defect has occurred when the search engine returns inaccurate or lower-relevance results, or when the search itself fails. For example, when the search model returns results for completely unrelated police equipment or other ranking systems as output data in response to a search query for the “Cheer of Police,” this may be determined as a defect.

The defect in the information verification model occurs when the information verification model incorrectly determines how relevant the search results are to the user query. The cases where a result with higher relevance is excluded or a result with lower relevance is selected may be determined as a defect.

The defect in the answer generation model occurs when the answer generation model fails to generate an appropriate and accurate answer to a user query. The cases where an inappropriate answer is generated based on the selected search results, or when an answer that excludes key information is generated, may be determined as a defect.

In the present disclosure, the first suitability determination model 110 may determine whether the first AI model 210 generates the inference result for agent invocation such that the inference result aligns with the user intent corresponding to the user input. As the determination result, when the inference result for agent invocation generated by the first AI model 210 reflects the user intent according to the user input, the first suitability determination model 110 may generate a first result value corresponding to suitability as the determination result. On the other hand, when the inference result for agent invocation generated by the first AI model 210 does not reflect the user intent according to the user input, the first suitability determination model 110 may generate a second result value corresponding to unsuitability as the determination result.

The plurality of suitability determination models 110 to 130 may determine the result of the AI model to be determined as suitable when no defect is detected in the result of the AI model to be determined. On the other hand, the plurality of suitability determination models 110 to 130 may determine the result of the AI model to be determined as unsuitable when a defect is detected in the result of the AI model to be determined.

More specifically, the first suitability determination model 110 may determine that the inference result for agent invocation generated by the first AI model 210 is suitable when the inference result for agent invocation corresponds to a case where it reflects the user intent according to the user input, and output the “first result value” as the suitability determination result. On the other hand, the first suitability determination model 110 may determine that the inference result for agent invocation generated by the first AI model 210 is unsuitable when the inference result for agent invocation corresponds to a case where it does not reflect the user intent according to the user input, and output the “second result value” as the suitability determination result.

The storage unit 140, also referred to as a database (DB) or memory, may store various pieces of information necessary (or otherwise, used) for building training data for the generative AI search system.

The storage unit 140 may store training data 141 to 143 generated based on the suitability determination results of each of the plurality of AI models 210 to 230.

The training data 141 (may also be referred to herein as first AI module training data) for improving the first AI model 210 may be configured such that the output data (result) of the first AI model 210 having a second result value mimics the output data (result) of the first AI model 210 having the first result value.

The training data 142 (may also be referred to herein as second AI module training data) for improving the second AI model 220 may be configured such that the output data (result) of the second AI model 220 having the second result value mimics the output data (result) of the second AI model 220 having the first result value.

In the present disclosure, the storage unit 140 may be provided in the training data building system 100 itself. Alternatively, at least a portion of the storage unit (database) may refer to at least one of an external database and cloud storage (or a cloud server). That is, the storage unit 140 may be sufficient as long as it is a space where information required (or otherwise, used) for building training data according to the present disclosure is stored, and it may be understood that there are no restrictions on physical space.

The ranking model 150 may be configured to rank input candidates for agent invocation, which meet the suitability criteria, based on the degree of suitability. For example, the ranking model 150 may score (numericalize or perform leveling of) the degree of suitability of input candidates for agent invocation based on certain criteria, and may rank the input candidates based on the score. In some example embodiments, the control unit may determine a user intent by applying an intent-classification LLM that performs topic extraction, task decomposition, or semantic clustering of the user input. The LLM may output an intent vector that includes required entities, contextual constraints, and expected output attributes. The ranking model may compare each improved inference result against the intent vector using a neural ranking architecture such as a bi-encoder or cross-encoder, and may compute a relevance score based on semantic alignment, information-coverage metrics, and contradiction-detection metrics. The ranking model may then generate an ordered list of inference results based on the computed relevance scores.

The control unit 160 may perform overall control necessary (or otherwise, used) for building training data for improving the generative AI search system 200. The control unit 160 may also be referred to as a processor.

In some example embodiments, the agent performance result may be generated by executing a retrieval engine, a search API, or an external service based on the agent invocation input. The performance result may include at least one of: (i) ranked document lists, (ii) retrieval confidence scores, (iii) text segments extracted from retrieved documents, (iv) embedding vectors generated by a transformer-based encoder, and (v) metadata associated with the retrieval context. The control unit may normalize such performance results into a unified representation format so that the suitability determination model and the training data building process may consistently evaluate and process the retrieved information.

The control unit 160 may use the suitability determination models 110 to 130 to determine the suitability of the AI models 210 to 230 constituting the generative AI search system 200 and generate the training data. The control unit 160 may train the AI models 210 to 230 based on the training data.

Furthermore, although not illustrated, the training data building system 100 may further include a communication unit. The communication unit may be configured to communicate (e.g., wired communication and/or wireless communication) with the generative AI search system 200, an external server, and/or a user terminal. According to some example embodiments, the user terminal may be one of a smartphone, a mobile phone, a navigation device, a personal computer, a laptop computer, a digital broadcasting terminal, a Personal Digital Assistant (PDA), a Portable Multimedia Player (PMP), a tablet, a game console, a wearable device, an augmented reality, a virtual reality device, and/or an Internet of things device. For example, the communication unit may receive various pieces of information (e.g., the user inputs) necessary (or otherwise, used) for suitability determination and training data building from the generative AI search system 200. According to some example embodiments, operations described herein as being performed by the communication unit may be performed by processing circuitry.

Hereinafter, a method for determining defects in a plurality of operations of a generative search system using the above-described configuration and determining whether the generative AI search system 200 is ultimately defective based on the determined defect will be described in detail.

In the present disclosure, a process of collecting user inputs that were input to a generative AI-based search system may be performed (S310, see FIG. 3). In the present disclosure, a process of collecting inference results for agent invocation corresponding to user inputs from an AI model that processes user inputs may be performed (S320, see FIG. 3).

To determine the suitability of the generative AI search system 200, the control unit 160 may collect the plurality of user inputs to the generative AI search system 200 and the inference results for agent invocation corresponding to the plurality of user inputs.

Here, the agent may include a search system that performs a search in response to a user query. According to some example embodiments, operations described herein as being performed by the agent and/or the search system may be performed by processing circuitry.

In this case, the user input may correspond to the user query, and the first AI model 210 may correspond to a model (e.g., a search query generation model) that generates agent input data (e.g., a search query) reflecting the user query.

The first AI model 210 may identify the user intent corresponding to the user input based on the user input being processed as the input data, and generate the search query for searching according to the user intent as the inference result.

In order to determine whether the first AI model 210 is suitable, the control unit 160 may collect the “user input” input as the input data to the first AI model 210 and the “inference result (e.g., search query) for agent invocation” corresponding to the output data of the first AI model according to the user input.

The control unit 160 may collect the plurality of user inputs input to the first AI model 210 and the inference results corresponding to each of the plurality of user inputs. The control unit 160 may collect log data (including record data for at least one of a state, input, output, event, and/or data processing process during the operation) generated while the first AI model 210 operates to infer the agent invocation for the user input. The control unit 160 may match all of the user input, the inference result corresponding to the user input, and the log data and process the user input, the inference result, and the log data as one dataset.

As illustrated in FIG. 4, the control unit 160 may perform a grouping process of grouping at least some of a plurality of user inputs 400 to a plurality of input groups 410, respectively.

The control unit 160 may group some user inputs having the same or similar meaning among the plurality of user inputs 400 into the same input group (or a single input group or only a single input group).

In the present disclosure, “having the same or similar meaning” may be understood as a case where the user inputs have the same intent (or a similar intent) or are used in a similar context. For example, “How's the weather today?” and “Tell me the weather today” include an intent to provide weather information and may be understood as having the same meaning (or similar meanings) although their wording differs. For another example, “Is it raining today?” includes an intent to provide rain forecast information and may be understood as having a similar meaning to the intent to provide weather information.

The control unit 160 may use a Large Language Model (LLM) to group user inputs having the same or similar meaning into the same group (or a single input group or only a single input group).

For example, the control unit 160 may group user input 1 401 (e.g., “What's the weather like today?”), user input 2 402 (e.g., “Tell me about today's weather”), and user input 3 403 (e.g., “Is it raining today?”) among the plurality of user inputs 400 into the same (e.g., a single or only a single) first input group 411 (input group A) based on the fact that each of the user input 1 401, user input 2 402, and user input 3 403 has a meaning identical or similar to a first meaning (e.g., the intent to provide weather information). For another example, the control unit 160 may group user input 4 404 (e.g., ‘Cheer of Police’), user input 5 405 (e.g., ‘Cheer of Police rank’), and user input 6 406 (‘police rank’) into a (e.g., a single or only a single) second input group 412 (input group B) based on the fact that each of the user input 4 404, user input 5 405, and user input 6 406 among the plurality of user inputs 400 has the same or a similar meaning as a second meaning (e.g., an intent to provide information) different from the first meaning.

In the present disclosure, a process of determining the suitability of each inference result using at least some of the plurality of user inputs may be performed (S330, see FIG. 3).

The control unit 160 may use the first suitability determination model 110 to determine the suitability of the inference result of the first AI model for the user input.

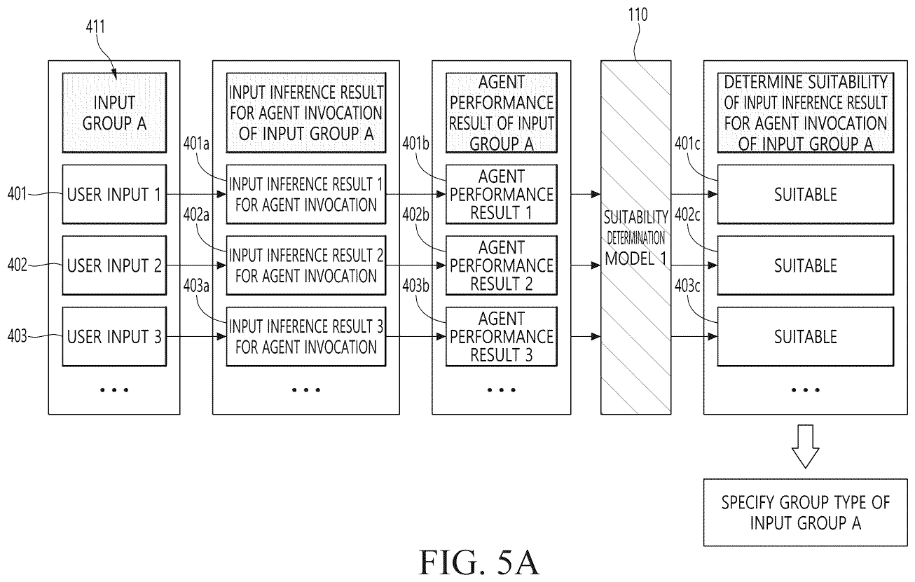

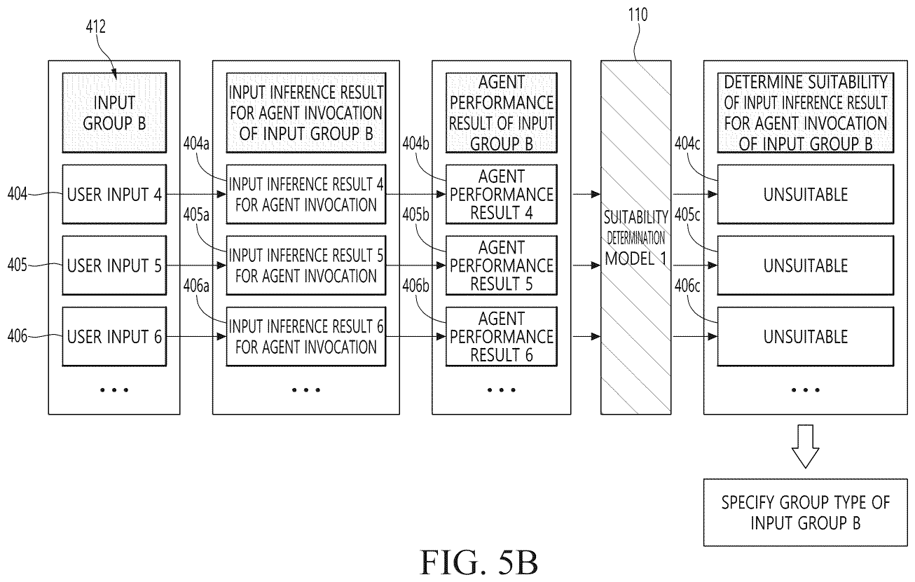

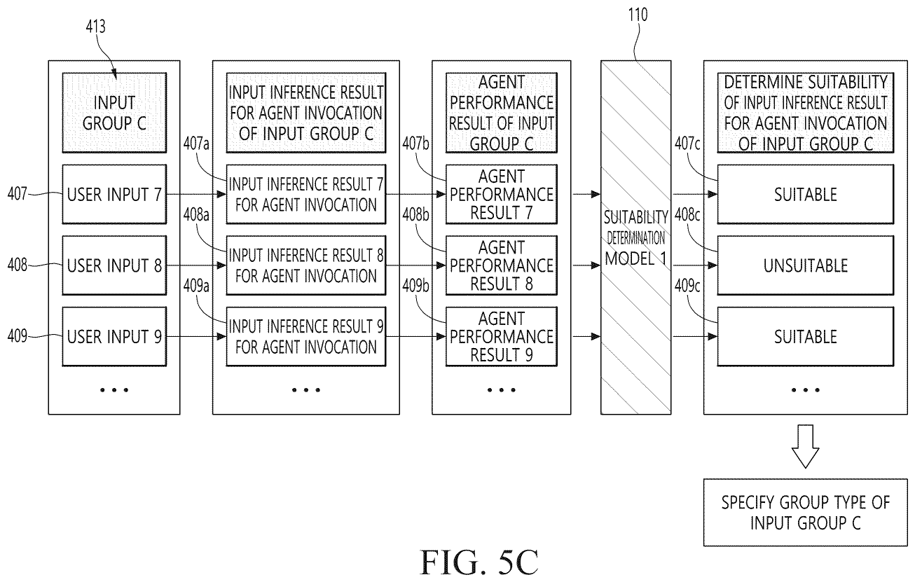

As illustrated in FIG. 5A, the control unit 160 may process at least some of the plurality of user inputs 401, 402, and 403, input inference results 401a, 402a, and 403a for agent invocation for each of the plurality of user inputs, and the agent invocation results 401b, 402b, and 403b (or agent performance results) as inputs to the first suitability determination model 110.

The first suitability determination model 110 may determine whether the first AI model 210 generates the inference result for agent invocation for the user input such that the inference result aligns with the user intent corresponding to the user input.

More specifically, the first suitability determination model 110 may determine whether the inference result for agent invocation generated by the first AI model 210 reflects the user intent according to the user input, thereby determining whether the inference result is suitable. The first suitability determination model 110 may determine that the inference result of the first AI model 210 is suitable when the user intent according to the user input is reflected in the inference result. On the other hand, when the user intent according to the user input is not reflected in the inference result, the first AI model 210 may determine that the inference result of the first AI model 210 is unsuitable.

For example, it is assumed the user input is “Cheer of Police.” When the first AI model 210 identifies that the user intent is to provide the information on the police rank system and infers the search query “[Police Rank], [Cheer of Police]” as the input for agent invocation, the first suitability determination model 110 may determine that the user intent is reflected in the inference result of the first AI model 210. On the other hand, even if the user query is “Cheer of Police,” when the first AI model 210 misinterprets the user query as associated with cheering for the police rather than police ranks and infers a search query “[cheering], [police], and [emotion]” as an input for agent invocation, the first suitability determination model 110 may determine that the user intent is not reflected in the inference result of the first AI model 210.

The first suitability determination model 110 may determine whether each of the plurality of inference results 401a, 402a, and 403a for the plurality of user inputs 401, 402, and 403 is suitable. The first suitability determination model 110 may determine whether the inference result 401a is suitable based on whether the user intent is reflected in the inference result 401a for the user input 1 401, and may determine whether the inference result 402a is suitable based on whether the user intent is reflected in the inference result 402a for the user input 2 402. The first suitability determination model 110 may determine whether the inference result 403a is suitable based on whether the user intent is reflected in the inference result 403a for the user input 3 403.

The control unit 160 may acquire a plurality of suitability determination results 401c, 402c, and 403c for each of the plurality of inference results 401a, 402a, and 403a from the first AI model 210.

Each of the plurality of suitability determination results 401c, 402c, and 403c may be matched with a first result value or a second result value. Here, the first result value corresponds to a value corresponding to a case where the AI model result is “suitable,” and may correspond to the suitability determination result for the inference result when the inference result for agent invocation generated by the first AI model 210 reflects the user intent according to the user input (e.g., alignment with the user intent). The second result value corresponds to a value corresponding to the case where the AI model result is “unsuitable,” and may match the suitability determination result for the inference result when the inference result for agent invocation generated by the first AI model 210 does not reflect the user intent according to the user input (e.g., lack of alignment or non-alignment with the user intent).

In the present disclosure, a process of specifying the group types of the plurality of input groups, each of which includes at least some of the plurality of user inputs, using the suitability determination results for each of the plurality of inference results may be performed (S340, see FIG. 3).

As illustrated in FIGS. 5A, 5B and 5C, the control unit 160 may use suitability determination results 401c to 403c, 404c to 406c, and 407c to 409c of inference results 401a to 403a, 404a to 406a, and 407a to 409a for agent invocation corresponding to the user inputs 401 to 403, 404 to 406, and 407 to 409 included in each of the plurality of input groups 411, 412, and 413 to differently specify the group types of each of the plurality of input groups 411, 412, and 413.

In this case, the control unit 160 may differently specify the group types of the plurality of input groups according to the distribution of the suitability determination results of the inference results for agent invocation corresponding to the user inputs included in each of the plurality of input groups.

The “distribution of the suitability determination results” described in the present disclosure refers to data representing the spread of how much the inference results reflect user intent, and may be understood as statistical information including, for example, at least one of the frequency, probability, and/or ratio for the first and second result values.

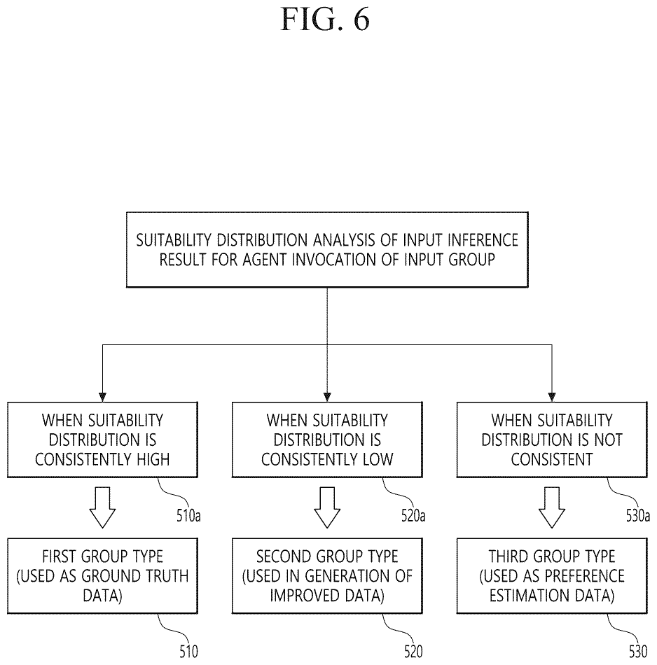

As illustrated in FIG. 6, the control unit 160 may specify the plurality of input groups as any one of a first group type 510, a second group type 520, and/or a third group type 530 based on the distribution of the suitability determination results for each of the plurality of input groups.

The control unit 160 may specify, among the plurality of input groups, the group type of the input group as the first group type 510 when the distribution of the first and second result values among the suitability determination values of the inference results for agent invocation included in each input group (e.g., a subset of the suitability determination values/results for each input group) meets (e.g., satisfies) a first criterion 510a (e.g., when the suitability distribution is consistently higher). For example, as illustrated in FIG. 5A, the suitability determination results 401c, 402c, and 403c of the first input group 411 are “suitable,” and accordingly, the suitability distribution of the first input group 411 has a higher proportion of the first result value. The control unit 160 may specify the group type of the first input group 411 as the first group type 510 based on the fact that the proportion of the first result value is higher in the suitability distribution of the first input group 411 (e.g., the proportion of the first result value exceeds a predetermined (or alternatively, given) threshold value of 98%).

The control unit 160 may specify, among the plurality of input groups, the group type of the input group as the second group type 520 when the distribution of the first and second result values among the suitability determination values of the inference results for agent invocation included in each input group meets a second criterion 520a (e.g., when the suitability distribution is consistently lower). For example, as illustrated in FIG. 5B, the suitability determination results 404c, 405c, and 406c of the second input group 412 are “unsuitable,” and accordingly, the suitability distribution of the second input group 412 has a higher proportion of the second result value. The control unit 160 may specify the group type of the second input group 412 as the second group type 520 based on the fact that the proportion of the second result value is higher in the suitability distribution of the second input group 412 (e.g., the proportion of the second result value exceeds a predetermined (or alternatively, given) threshold of 98%).

Furthermore, the control unit 160 may specify, among the plurality of input groups, the group type of the input group as the third group type 530 when the distribution of the first and second result values among the suitability determination values of the inference results for agent invocation included in each input group meets a third criterion 530a (e.g., when the suitability distribution is inconsistent). For example, as illustrated in FIG. 5C, the suitability determination results 407c, 408c, and 409c of the third input group 413 include both “unsuitable” and “suitable” (almost 50:50). Therefore, the suitability distribution of the third input group 413 has the non-uniform first and second result values. Based on the suitability distribution of the second input group 413 being non-uniform, the control unit 160 may specify the group type of the third input group 413 as the third group type 530.

In order to train the first AI model, the control unit 160 may use the user inputs of each of the plurality of input groups and the inference results for agent invocation as the training data.

In this case, the user inputs of each of the plurality of input groups and the agent invocation inference results may be composed of respectively different training datasets based on each of the plurality of input groups.

The control unit 160 may generate training datasets of respectively different types based on the group types of each of the plurality of input groups. The generated training datasets of different types may be differently used for training the first AI model.

The control unit 160 may use the user inputs and inference results for agent invocation of the first input group corresponding to the first group type as ground truth data for training the first AI model.

The control unit 160 may use the user inputs and inference results for agent invocation of the second input group corresponding to the second group type as the input data to acquire improvement data from the trained first AI model.

Furthermore, the control unit 160 may use the user inputs and inference results for agent invocation of the third input group corresponding to the third group type as preference estimation data in a form that favors the side with higher suitability to acquire the improvement data from the trained first AI model.

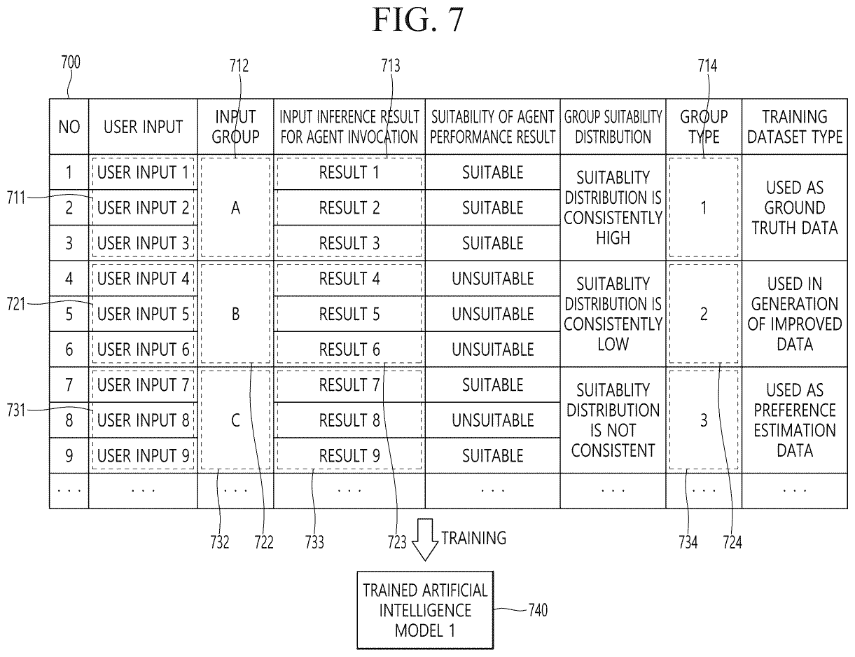

As illustrated in FIG. 7, at least one of the user inputs, input groups in which the user inputs are grouped, inference results for the user inputs, agent performance results based on the inference results, suitability determination results of the inference results, suitability distributions of the input groups, group type of the input groups, and training dataset type of the input groups may be matched and stored as matching information in the storage unit 140. The control unit 160 may use the matching information to build the training data for training the first AI model.

The group type may be specified based on the distributions of the first result value and the second result value among suitability determination values of inference results 713, 723, and 733 for agent invocation included in each input group among a plurality of input groups 712, 722, and 732, and respectively different training datasets may be generated based on the specified group type.

For example, the control unit 160 may generate a first type training dataset composed of user inputs 711 of a first input group 712 (e.g., “input group A”) having a first group type 714 among the plurality of input groups and inference results 713 for agent invocation. Furthermore, the control unit 160 may train the first AI model using the first type training dataset as the ground truth data.

The control unit 160 may generate a second type training dataset composed of user inputs 721 of a second input group 722 (e.g., “input group B”) having a second group type 724 among the plurality of input groups and inference results 723 for agent invocation. Furthermore, for obtaining improved data from the first AI model 740 trained by using the ground truth data, the control unit 160 may use the plurality of user inputs 721, included in the second type training dataset, as input data of the trained first AI model 740.

In addition, the control unit 160 may generate a third type training dataset composed of user inputs 731 of a third input group 732 (e.g., “input group C”) having third group type 734 among the plurality of input groups and inference results 733 for agent invocation. Furthermore, the control unit 160 may utilize the third type training dataset as preference estimation data to train the first AI model.

The control unit 160 may use the trained first AI model 740 to generate a plurality of improved inference results for agent invocation corresponding to specific user inputs of the second type input group.

Here, the “plurality of improved inference results” may refer to new inference results of the trained first AI model 740 for each of the plurality of user inputs in the second input group.

The control unit 160 may process a specific user input of the second input group corresponding to the improved data as the input data to the first AI model 210 trained with the training data, and acquire the improved inference result for agent invocation.

As illustrated in FIG. 8A, the control unit 160 may process a specific user input 810 among the plurality of user inputs included in the second type group as inputs to the trained first AI model 740, thereby acquiring a plurality of improved inference results 820. For example, when the pre-training (or training) first AI model 210 infers an incorrect result for the user query “Cheer of Police,” the control unit 160 may re-input “Cheer of Police” to the trained first AI model 210. The control unit 160 may acquire the plurality of improved inference results 820 (e.g., search query) for “Cheer of Police” from the trained first AI model 210. These inference results may be processed as the input data to an agent and, in the present disclosure, may also be referred to as an agent input. The control unit 160 may input the plurality of improved inference results 820 to the agent and acquire a plurality of agent performance results 830 corresponding to each of the plurality of improved inference results from the agent.

To determine the suitability of the trained first AI model 740, the control unit 160 may process at least some of the specific user input 810, the plurality of improved inference results 820, and the plurality of agent performance results 830 as the input data to the first suitability determination model 110.

The first suitability determination model 110 may generate the suitability determination results for each of the plurality of improved inference results 820 based on whether the user intent for the specific user input 810 (e.g., “Cheer of Police”) is reflected in each of the plurality of improved inference results 820. In other words, the first suitability determination model 110 may generate the plurality of suitability determination results for each of the plurality of improved inference results 820. Since the suitability determination in the first suitability determination model 110 has been described above, a detailed description thereof will be omitted.

The control unit 160 may determine whether the plurality of improved inference results 820 has actually been improved based on the plurality of suitability determination results for the plurality of improved inference results 820. For example, when at least some of the plurality of suitability determination results correspond to the first result value corresponding to the suitability, the control unit 160 may determine that the plurality of inference results has actually been improved. The control unit 160 may rank the plurality of improved inference results 820 and provide improvement verification data 870 for the first AI model. Alternatively, when all of the plurality of suitability determination results are the second result value corresponding to unsuitability, the control unit 160 may again acquire the plurality of improved inference results 820 from the trained first AI model 740.

When it is determined that the plurality of inference results have been actually improved, the control unit 160 may rank the plurality of improved inference results 820.

The control unit 160 may determine the relevance of the plurality of agent performance results 830 corresponding to each of the plurality of improved inference results 820 based on the user intent according to the specific user input 810 (e.g., “Cheer of Police”). For example, the control unit 160 may determine the user intent according to the specific user input (e.g., “Cheer of Police”) and the relevance of each of the plurality of agent performance results 830 based on whether the agent's search results include information corresponding to the user intent, information on how relevant the agent's search results are to the user intent, etc.

The control unit 160 may rank the plurality of improved inference results 820 based on the relevance. The control unit 160 may use the ranking model 150 to rank the plurality of improved inference results 820 corresponding to the agent's performance results in order of highest relevance to the user intent.

The control unit 160 may provide the user with the specific user input 810 and the ranking information of the plurality of improved inference results 820 as improvement verification data 870 of the first AI model.

As illustrated in FIG. 8B, a trained detailed query candidate generation model is taken as an example of the trained first AI model 740 to describe improvement verification of the first AI model 740. The trained detailed query candidate generation model will also be described with reference numeral “740,” like the trained first AI model. It is assumed that the control unit 160 incorrectly infers the results of the specific user input query 840 “Tell me today's weather and recommend an outerwear that suits today's weather” in the pre-training (or training) detailed query candidate generation model. The control unit 160 may acquire a plurality of detailed queries 851 and 852 for the specific user input query 840 as improved inference results 850 from the trained detailed query candidate generation model 740. The control unit 160 may use the first suitability determination model 110 to determine the suitability based on whether the user intent corresponding to the specific user input query 840 is reflected in each of the plurality of improved detailed queries 851 and 852. The control unit 160 may acquire suitability determination results 860 for each of the plurality of improved detailed queries 851 and 852. These suitability determination results 860 may be composed of scores. For example, the suitability determination results may be relevance 5 861 and relevance 0 862. The control unit 160 may determine whether the plurality of improved detailed queries 851 and 852 have actually been improved based on the plurality of suitability determination results for the plurality of improved detailed queries 851 and 852. As the determination result, when the plurality of detailed queries 851 and 852 have actually been improved, the control unit 160 may use the ranking model 150 to perform ranking on each of the plurality of improved detailed queries 851 and 852. The control unit 160 may provide a user with improvement verification data 870 including the ranking information. Alternatively, when the plurality of detailed queries 851 and 852 have not actually been improved, the control unit 160 may again acquire new inference results for the specific user input query 840 using the trained detailed query candidate generation model 740. The control unit 160 may repeatedly perform the improvement verification on the first AI model using the inference results acquired again.

Furthermore, the generative AI search system 200 may input the plurality of improved inference results 820 to an agent, and acquire the plurality of agent performance results corresponding to each of the plurality of improved inference results 820 from the agent. The control unit 160 may determine the relevance of the plurality of agent performance results 830 based on the user intent according to the specific user input 810. Specifically, the first suitability determination model 110 may determine whether the plurality of improved inference results 820 generated by the first AI model align with the user intent according to the specific user input 810.

Further, when the plurality of improved inference results 820 generated by the trained first AI model 210 reflect the user intent according to the specific user input 810, the first suitability determination model 110 may generate the first result value corresponding to suitability as the determination result. On the other hand, when the plurality of inference results generated by the first AI model 210 do not reflect the user intent according to the user input, the first suitability determination model 110 may generate the second result value corresponding to unsuitability as the determination result.

The control unit 160 may use the determination result of each of the plurality of improved inference results 820 determined based on the user intent according to the specific user input 810 of the second input group to determine the relevance of the user intent corresponding to the specific user input and the plurality of agent performance results 830. For example, based on the degree of relevance of the improved first inference result having a first relevance score, the improved first inference result may be understood as having the first result value. On the other hand, based on the fact that the degree of relevance of the improved second inference result not satisfying the relevance criterion has the second relevance score, the improved second inference result may be understood as having the second result value.

Furthermore, the control unit 160 may use the ranking model 150 to rank the plurality of improved inference results based on the relevance of the plurality of agent performance results 830. Specifically, the ranking model 150 may score the degree of relevance of the plurality of improved inference results that satisfy a relevance criterion based on the preset (or alternatively, given) criteria, based on the fact that at least one of the plurality of agent performance results has the first result value, and rank the plurality of improved inference results 820.

In this case, the control unit 160 may re-input the plurality of improved inference results 820 to the trained first AI model 740 based on the fact that there is no improved inference result having the first result value as the relevance score among the plurality of improved inference results 820. Furthermore, the control unit 160 may repeat the above process to rank the improved inference results having the first result value.

The control unit 160 may collect the plurality of performance results output from the agent of the generative AI search system 200. The control unit 160 may collect the inference results corresponding to each of the plurality of performance results from the AI model that processes each of the plurality of performance results.

In the present disclosure, the first AI model 210 may be a search query model that generates the search query corresponding to the user query. The agent may be a search system that performs a search for the search query. The second AI model 220 may be an answer generation model that uses the search results to generate an answer corresponding to the user input.

The control unit 160 may collect the search results (agent performance results) and the inference results (answers) of the second AI model 220 corresponding to the above performance results to determine whether the second AI model 220 generates an appropriate answer using the search results.

The second AI model 220 may generate the answer corresponding to the agent performance result as the inference result (or output data) based on the agent performance result being processed as the input data. The agent performs the search corresponding to each of the plurality of user inputs, and there may be the plurality of performance results corresponding to each of the plurality of user inputs.

The second AI model 220 may generate the plurality of inference results corresponding to each of the plurality of performance results.

The control unit 160 may collect the plurality of performance results and the plurality of inference results (or answers) of the second AI model corresponding to each of the plurality of performance results.

In this case, the control unit 160 may collect the agent performance results performed by a suitable search query and the inference results of the second AI model 220 according to the performance results.

The suitable search query may be understood as matching the suitability determination results of the first result value with the inference results for agent invocation.

For convenience of description, the following description will be given as an example in which only the agent performance results performed by the suitable search query and the inference results of the second AI model 220 according to the performance results are collected.

As illustrated in FIG. 9, the control unit 160 may perform a grouping process that groups at least some of the plurality of agent performance results 900 into each of the plurality of agent result groups 910.

The control unit 160 may group some agent performance results 900 having the same or similar meaning (or search results) among the plurality of agent performance results 900 into the same agent result group (or a single agent result group or only a single agent result group).

In the present disclosure, “having the same or similar meaning” may be understood as the case where the agent performance result have the same intent (or a similar intent) or are used in a similar context. For example, “Search result: Seoul weather information” and “Search result: Seoul current temperature” include weather information.

The control unit 160 may use the Large Language Model (LLM) to group the agent performance results having the same or similar meaning into the same group (e.g., a single group or only a single group).

The control unit 160 may group agent performance result 1 901, agent performance result 2 902, and agent performance result 3 903 among the plurality of agent performance results 900 into the same (or the single) first agent result group 911 (agent result group A) based on the fact that each of the agent performance result 1 901, agent performance result 2 902, and agent performance result 3 903 has a meaning identical or similar to the first meaning (or the first search result). The control unit 160 may group agent performance result 4 904, agent performance result 5 905, and agent performance result 6 906 among the plurality of agent performance results 900 into a second agent result group 912 (agent result group B) different from the first agent result group 911 based on the fact that each of the agent performance result 4 904, agent performance result 5 905, and agent performance result 6 906 has a meaning identical or similar to the second meaning (or the second search result) different from the first meaning.

The control unit 160 may use at least some of the plurality of performance results to determine the suitability of each inference result of the second AI model 220.

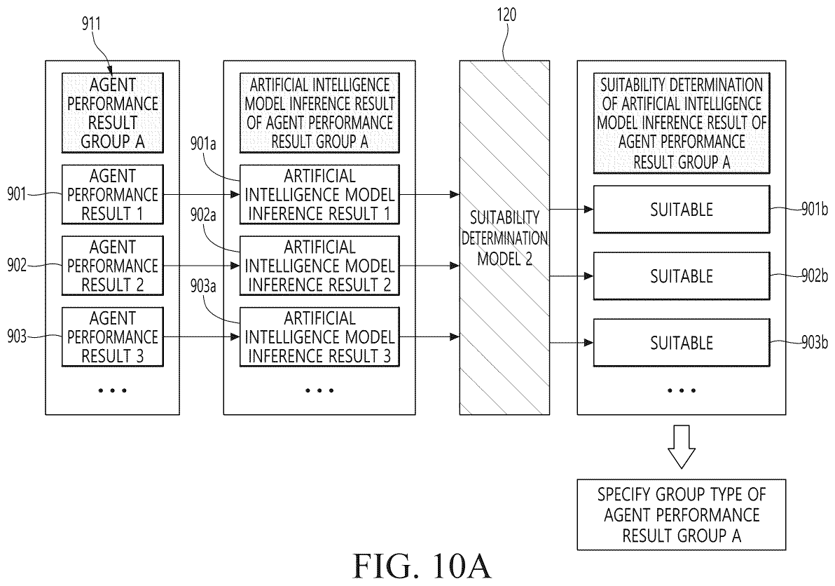

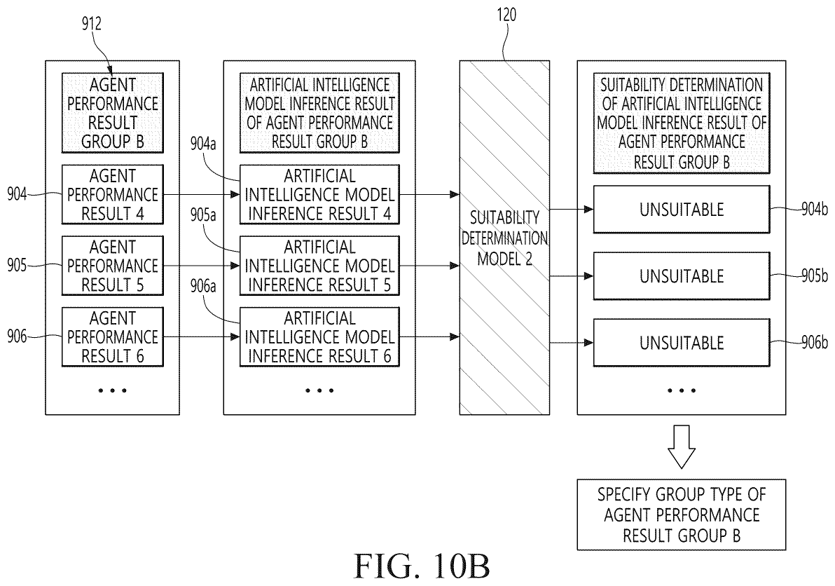

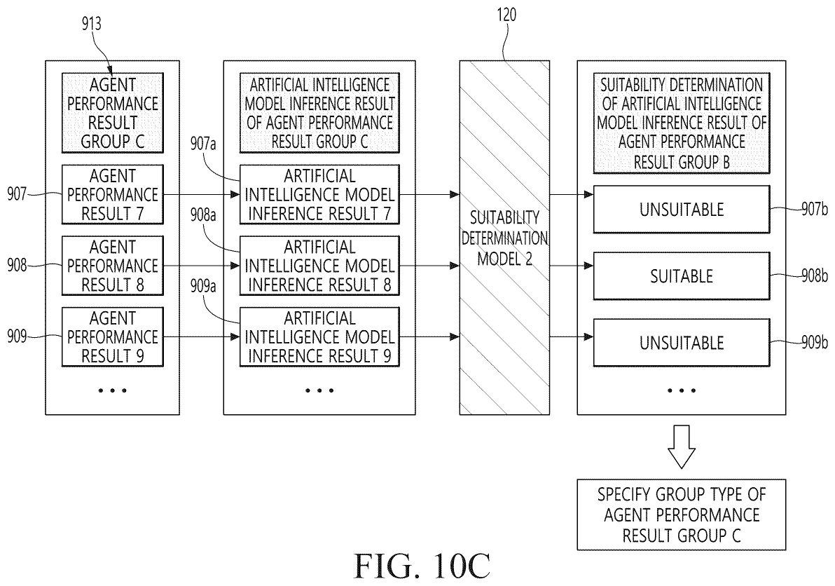

As illustrated in FIG. 10A, the control unit 160 may process, as inputs to the second suitability determination model 120, at least some of the plurality of agent performance results 901, 902, and 903 and inference results 901a, 902a, and 903a of the second AI model 220 for each of the plurality of agent performance results. Furthermore, the control unit 160 may process a user input (or user query) and the inference result (search query) for agent invocation for the user input as inputs to the second suitability determination model 120.

The second suitability determination model 120 may determine whether the second AI model 220 generates the inference result using the agent performance results such that the inference result aligns with the user intent corresponding to the user input.

More specifically, the second suitability determination model 120 may determine, from the inference result inferred by the second AI model 220 based on the agent performance result, whether the user intent according to the user input is reflected, whether the user's desired information is included, whether necessary (or appropriate, significant, etc.) information is omitted, whether unnecessary information is included, whether incorrect information is included, and whether an answer sentence is appropriately generated, thereby determining whether the inference results of the second AI model 220 are suitable. For example, even when the user input is “Cheer of Police,” when the second AI model 220 selects information about police officers from the search results and infers “Police officer is a rank assigned upon initial appointment” as an answer, the inference result may be determined as unsuitable.

The second suitability determination model 120 may determine whether each of the plurality of inference results 901a, 902a, and 903a for the plurality of agent performance results 901, 902, and 903 is suitable.

The control unit 160 may acquire a plurality of suitability determination results 901b, 902b, and 903b for each of the plurality of inference results 901a, 902a, and 903a of the second AI model 220 from the second suitability determination model 120.

Each of the plurality of suitability determination results 901b, 902b, and 903b of the second AI model 220 may match the first result value or the second result value.

Here, the first result value corresponds to a value corresponding to the case where the inference result of the second AI model 220 is “suitable,” and the second result value corresponds to a value corresponding to the case where the inference result of the second AI model 220 is “unsuitable.”

The control unit 160 may use the suitability determination results for each of a plurality of inference results to specify the group types of each of the plurality of agent result groups that include at least some of the plurality of agent performance results.

As illustrated in FIGS. 10A, 10B, and 10C, the control unit 160 may use suitability determination results 901b to 903b, 904b to 906b, and 907b to 909b of inference results 901a to 903a, 904a to 906a, and 907a to 909a of the second AI model 220 corresponding to the agent performance results 901 to 903, 904 to 906, and 907 to 909 included in each of the plurality of agent result groups 911, 912, and 913 to differently specify the group types of each of the plurality of agent result groups 911, 912, and 913.

In this case, the control unit 160 may differently specify the group types of the plurality of agent result groups based on the distribution of the suitability determination results of the inference results of the second AI model 220 corresponding to the agent performance results included in each of the plurality of agent result groups.

As described above, the “distribution of the suitability determination results” described in the present disclosure refers to data representing the spread of how much the inference results reflect user intent, and may be understood as statistical information including, for example, at least one of the frequency, probability, and ratio for the first and second result values.

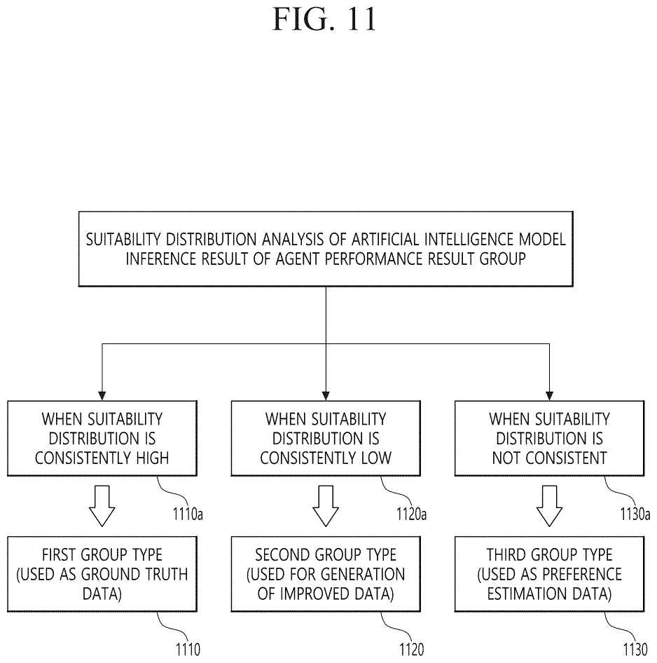

As illustrated in FIG. 11, the control unit 160 may specify the plurality of agent result groups as any one of a first group type 1110, a second group type 1120, and/or a third group type 1130 based on the distribution of the suitability determination results for each of the plurality of agent result groups.

The control unit 160 may specify, among the plurality of agent result groups, the group type of the agent result group as the first group type 1110 when the distribution of the first and second result values among the suitability determination values of the inference results for the second AI model 220 included in each agent result group meets a first criterion 1110a (e.g., when the suitability distribution is consistently higher). For example, as illustrated in FIG. 10A, the suitability determination results 901b, 902b, and 903b of the first agent result group 911 are “suitable,” and accordingly, the suitability distribution of the first agent result group 911 has a higher proportion of the first result value. The control unit 160 may specify the group type of the first agent result group 911 as the first group type 1110 based on the fact that the proportion of the first result value is higher in the suitability distribution of the first agent result group 911 (e.g., the proportion of the first result value exceeds a predetermined (or alternatively, given) threshold value of 98%).

The control unit 160 may specify, among the plurality of agent result groups, the group type of the agent result group as the second group type 1120 when the distribution of the first and second result values among the suitability determination values of the inference results for the second AI model 220 included in each agent result group meets a second criterion 1120a (e.g., when the suitability distribution is consistently lower). For example, as illustrated in FIG. 10B, suitability determination results 904b, 905b, and 906C of the second agent result group 912 are “unsuitable,” and accordingly, the suitability distribution of the second agent result group 912 has a higher proportion of the second result value. The control unit 160 may specify the group type of the second agent result group 912 as the second group type 1120 based on the fact that the proportion of the second result value is higher in the suitability distribution of the second agent result group 912 (e.g., the proportion of the second result value exceeds a predetermined (or alternatively, given) threshold value of 98%).

Furthermore, the control unit 160 may specify, among the plurality of agent result groups, the group type of the agent result group as the third group type 1130 when the distribution of the first and second result values among the suitability determination values of the inference results for the second AI model 220 included in each agent result group meets a third criterion 1130a (e.g., when the suitability distribution is not consistent). For example, as illustrated in FIG. 10C, the suitability determination results 907b, 908b, and 909b of the third agent result group 913 include both “unsuitable” and “suitable” (almost 50:50). Therefore, the suitability distribution of the third agent result group 913 has the non-uniform first and second result values. Based on the suitability distribution of the third agent result group 913 being non-uniform, the control unit 160 may specify the group type of the third agent result group 913 as the third group type 1130.

The control unit 160 may use the agent performance results of each of the plurality of agent result groups 911, 912, and 913 and the inference results of the second AI model 220 as the training data to train the second AI model 220.

In this case, the agent performance results of each of the plurality of agent result groups and the inference results of the second AI model 220 may be composed of respectively different training datasets based on each of the plurality of agent result groups.

The control unit 160 may generate training datasets of respectively different types based on the group types of each of the plurality of agent result groups. The generated training datasets of different types may be differently used for training the second AI model 220.

The control unit 160 may use the agent performance results of the first agent result group corresponding to the first group type and the inference results of the second AI model 220 as the ground truth data for training the second AI model 220.

The control unit 160 may use the agent performance results of the second agent result group corresponding to the second group type and the inference results of the second AI model 220 as the input data, thereby acquiring the improved data from the trained second AI model 220.

Furthermore, the control unit 160 may use the agent performance results of the third agent result group corresponding to the third group type and the inference results of the second AI model 220 as preference estimation data in a form that favors the side with higher suitability, thereby acquiring the improved data from the trained second AI model 220.

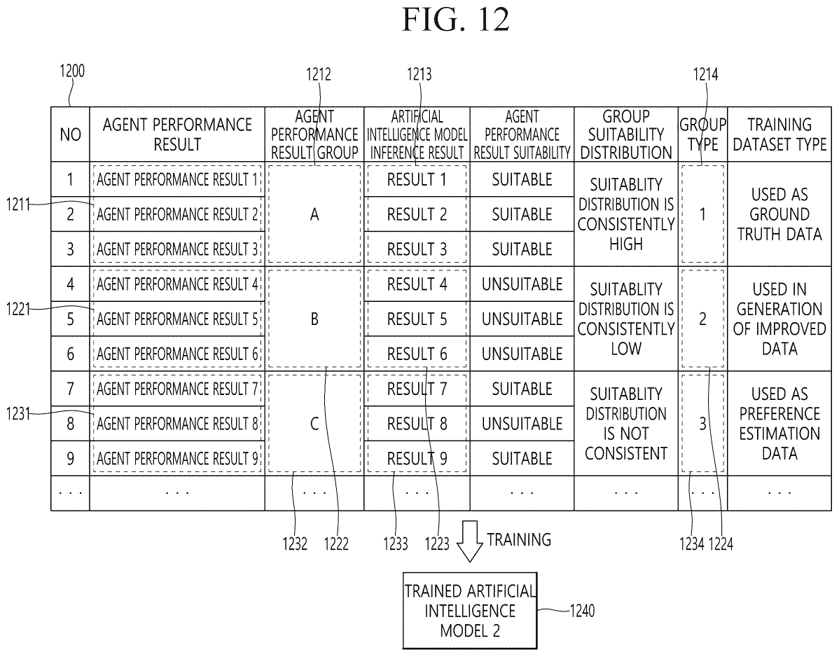

As illustrated in FIG. 12, at least one of the agent performance results, the agent result group in which the agent performance results are grouped, the inference results of the second AI model 220, the suitability determination results for the inference results, the suitability distribution of the agent result group, the group type of the agent result group, and/or the training dataset type of the agent result group may be matched and stored as matching information in the storage unit 140. The control unit 160 may use the matching information to build the training data for training the second AI model.

The group type may be specified based on the distributions of the first result value and the second result value among suitability determination values of inference results 1213, 1223, and 1233 of the second AI model 220 included in each input group among a plurality of agent result groups 1212, 1222, and 1232, and respectively different training datasets may be generated based on the specified group type.

For example, the control unit 160 may generate a first type training dataset composed of an agent performance results 1211 of the first agent result group 1212 (e.g., “agent result group A”) having a first group type 1214 among the plurality of agent result groups and an inference result 1213 of the second AI model 220 using the performance results. Furthermore, the control unit 160 may train the second AI model 220 using the first type training dataset as the ground truth data.

The control unit 160 may generate a second type training dataset composed of an agent performance results 1221 of the second agent result group 1222 (e.g., “agent result group B”) having a second group type 1224 among the plurality of agent result groups and an inference result 1223 of the second AI model 220. Furthermore, the control unit 160 may use the second type training dataset as the input data to a trained second AI model 1240 to acquire the improved data from a trained second AI model 1240 using the ground truth data.

The control unit 160 may generate a third type training dataset composed of an agent performance results 1231 of the third agent result group 1232 (e.g., “agent result group C”) having a third group type 1234 among the plurality of agent result groups and an inference result 1233 of the second AI model 220. Furthermore, the control unit 160 may train the second AI model 220 using the third type training dataset as the preference estimation data.

The control unit 160 may use the trained second AI model 1240 to generate improved inference results corresponding to specific performance results of the second type input group.

Here, the “improved inference results” may refer to new inference results of the trained second AI model 1240 for each of the plurality of agent performance results included in the second input group.

The control unit 160 processes specific performance results corresponding to the improved data as input data to the second AI model 1240 trained using the training data, thereby acquiring the improved inference results from the trained second AI model 1240. In other words, the control unit 160 may obtain new answers generated by the trained second AI model 1240 from the search results as the improved inference results.

As illustrated in FIG. 13A, the control unit 160 may process a specific performance result 1310 among the plurality of performance results included in the second type group as inputs to the trained second AI model 1240, thereby acquiring the plurality of improved inference results 1320. For example, when the pre-training (or training) second AI model 220 selects information unrelated to Cheer of Police from the “Cheer of Police search results” and generates an answer, the control unit 160 may re-input the Cheer of Police search results to the trained second AI model 1240. Furthermore, the control unit 160 may acquire a plurality of improved answers as the improved inference results 1320 using the “Cheer of Police search results” from the trained second AI model 1240.

To determine the suitability of the trained second AI model 1240, the control unit 160 may process at least some of the specific performance result 1310, the plurality of improved inference results 1320, and the plurality of agent performance results as the input data to the second suitability determination model 120.

The second suitability determination model 120 may determine whether the plurality of improved inference results 1320 are suitable by determining, from the plurality of improved inference results 1320, whether the user intent according to the user input is reflected, whether the user's desired information is included, whether necessary (or appropriate, significant, etc.) information is omitted, whether unnecessary information is included, whether incorrect information is included, and whether the response sentence is appropriately generated. Since the suitability determination in the second suitability determination model 120 has been described above, a detailed description thereof will be omitted.

The control unit 160 may determine whether the plurality of improved inference results 1320 has actually been improved based on the plurality of suitability determination results for the plurality of improved inference results 1320. For example, when at least some of the plurality of suitability determination results correspond to the first result value corresponding to the suitability, the control unit 160 may determine that the plurality of inference results has actually been improved. The control unit 160 may rank the plurality of improved inference results 1320 and provide improvement verification data 1350 for the second AI model. Alternatively, when all of the plurality of suitability determination results are the second result value corresponding to unsuitability, the control unit 160 may again acquire the plurality of improved inference results 1320 from the trained second AI model 1240.

When it is determined that the plurality of inference results has been actually improved, the control unit 160 may use the ranking model 150 to rank the plurality of improved inference results 1320. The control unit 160 may provide the user with the ranking information for the plurality of improved inference results 1320 as the improvement verification data 1350 of the second AI model.

As illustrated in FIG. 13B, a trained summary statement candidate generation model is taken as an example of the trained second AI model 1240 to describe improvement verification of the second AI model 1240. The trained summary statement candidate generation model will also be described with reference numeral “1240,” like the trained second AI model. In this case, the search result may be a result searched by the inference result of the first AI model 210 determined to be suitable by the first suitability determination model 110. It is assumed that the control unit 160 selects an incorrect search result (e.g., search result #1, 1321) among search results 1321 and 1322 in a pre-training (or training) summary statement candidate generation model to generate a summary statement. The control unit 160 may process the search result as input to the trained summary statement candidate generation model 1240 to acquire the plurality of improved summary statements 1331 and 1332 as the improved inference results 1330. The control unit 160 may use the second suitability determination model 120 to determine the suitability of each of the plurality of improved summary statements 1331 and 1332. The control unit 160 may acquire suitability determination results 1340 for each of the plurality of improved summary statements 1331 and 1332. These suitability determination results 1340 may be composed of scores. For example, the suitability determination results may be summary score 1 1341 and summary score 4 1342. The control unit 160 may determine whether the plurality of improved summary statements 1331 and 1332 have actually been improved based on the plurality of suitability determination results 1341 and 1342 for each of the plurality of improved summary statements 1331 and 1332. As the determination result, when the plurality of summary statements have actually been improved, the control unit 160 may use the ranking model 150 to perform ranking on each of the plurality of improved summary statements 1331 and 1332. The control unit 160 may provide a user with improvement verification data 1350 including the ranking information. Alternatively, when the plurality of summary statements have not actually been improved, the control unit 160 may again acquire new inference results for the search result query using the trained summary statement candidate generation model 1240. The control unit 160 may repeatedly perform the improvement verification on the second AI model using the plurality of summary statements acquired again.

According to the method and system for building training data based on Artificial Intelligence (AI) of the present disclosure, by collecting the plurality of user inputs input to the generative AI search system and the plurality of inference results corresponding to each of the plurality of user inputs for agent invocation, it is possible to improve the generative AI search system.

More specifically, according to the method and system for building training data based on artificial intelligence of the present disclosure, it is possible to determine the suitability of each inference result using at least some of the plurality of user inputs and specify the group types of each of the plurality of input groups using the suitability determination results for each of the plurality of inference results. As a result, according to the present disclosure, it is possible to build the training data for improving the generative AI search system. In particular, the present disclosure may enhance the objectivity by minimizing (or reducing) the human intervention and may be applied even in the environments where the fine-tuning of agents is difficult.

Conventional devices and methods for training an Artificial Intelligence (AI) model in a generative AI search system train the AI model according to the subjective preferences of users of the generative AI search system. For example, the conventional devices and methods train the AI model by using search results selected by a user from among search results obtained using the generative AI search system as correct search results. Accordingly, the resulting trained AI model is insufficiently accurate due to the subjective biases of the users.

However, according to some example embodiments, improved devices and methods are provided for training an AI model in a generative AI search system. For example, the improved devices and methods involve determining a suitability of inferences generated by the AI model using a suitability determination model. The suitability determination model may be based on, for example, at least one of a Large Language Model (LLM), a rule-based model and/or a statistical-based model. The improved devices and methods involve training the AI model based on the determined suitability, and thus, based on objective (or more objective) data, thereby eliminating (or reducing) the effect of user bias to improve the accuracy of the trained AI model. Accordingly, the improved devices and methods overcome the deficiencies of the conventional devices and methods to at least increase the accuracy of the resulting trained AI model.

Furthermore, as described above, the present disclosure may be implemented as computer-readable codes or instructions on a non-transitory medium recording the program. In other words, the present disclosure may be provided in the form of the program.

The non-transitory computer-readable medium may include all kinds of recording devices in which computer system-readable data is stored. An example of the non-transitory computer-readable medium may include a Hard Disk Drive (HDD), a Solid State Disk (SSD), a Silicon Disk Drive (SDD), a Read Only Memory (ROM), a Random Access Memory (RAM), a Compact Disk Read Only Memory (CD-ROM), a magnetic tape, a floppy disk, an optical data storage, and the like.

Furthermore, the non-transitory computer-readable medium may be the server or cloud storage that includes storage and may be accessed by the electronic device via communication. In this case, the computer may download the program according to the present disclosure from the server or cloud storage via wired or wireless communication.

Furthermore, in the present disclosure, the computer described above is an electronic device equipped with a processor, e.g., a Central Processing Unit (CPU), and there are no particular limitations on its type.

The above-described detailed description is to be interpreted as being illustrative rather than being restrictive in all aspects. The scope of the present disclosure is to be determined by reasonable interpretation of the claims, and all modifications within an equivalent range of the present disclosure fall in the scope of the present disclosure.

What is claimed is:

1. A method for building training data for Artificial Intelligence (AI) models, the method comprising:
collecting a plurality of user inputs input to a generative AI search system;
collecting a plurality of inference results for agent invocation from an AI model that processes each of the plurality of user inputs, each among the plurality of inference results corresponding to one among the plurality of user inputs;
determining a respective suitability of each among the plurality of inference results using at least some among the plurality of user inputs to obtain suitability determination results; and
specifying a respective group type of each among a plurality of input groups using the suitability determination results, each among the plurality of input groups including at least some among the plurality of user inputs.

2. The method of claim 1, further comprising:
grouping the at least some among the plurality of user inputs into each among the plurality of input groups such that user inputs having a similar meaning among the plurality of user inputs are grouped in a same input group among the plurality of input groups.

3. The method of claim 2, wherein
a first input group among the plurality of input groups includes first user inputs among the plurality of user inputs having a first meaning;
the plurality of inference results include first inference results for agent invocation corresponding to each of the first user inputs, the first inference results corresponding to an output of the AI model based on the first user inputs;
a second input group among the plurality of input groups includes second user inputs among the plurality of user inputs having a second meaning different from the first meaning; and
the plurality of inference results include second inference results for agent invocation corresponding to each of the second user inputs, the second inference results corresponding to an output of the AI model based on the second user inputs.

4. The method of claim 1, wherein the determining includes determining whether the AI model generates the plurality of inference results such that each among the plurality of inference results aligns with a user intent of a corresponding one among the plurality of user inputs.

5. The method of claim 4, wherein
each of the plurality of inference results has a first result value or a second result value is matched; and
the determining including storing the plurality of inference results in a storage unit.

6. The method of claim 5, wherein, in the specifying includes specifying the respective group type of each among the plurality of input groups based on a distribution of the suitability determination results corresponding to the at least some among the plurality of user inputs included in each among the plurality of input groups.

7. The method of claim 6, wherein the specifying includes specifying the respective group type of each corresponding input group among the plurality of input groups as,
a first group type corresponding to a first distribution of the first result value and the second result value among a subset of the suitability determination results for the corresponding input group satisfying a first criterion, or
a second group type corresponding to a second distribution of the first result value and the second result value among the subset of the suitability determination results for the corresponding input group satisfying a second criterion.

8. The method of claim 7, wherein
the first result value corresponds to an inference result among the plurality of inference results reflecting the user intent of a corresponding one among the plurality of user inputs; and
the second result value corresponds to an inference result among the plurality of inference results not reflecting the user intent of a corresponding one among the plurality of user inputs.

9. The method of claim 7, further comprising:
forming a different training data set based on each among the plurality of input groups to obtain a plurality of training data sets, each among the plurality of training data sets having training data including the at least some among the plurality of user inputs included in a corresponding one among the plurality of input groups.

10. The method of claim 9, further comprising:
differently training the AI model using each respective training data set among the plurality of training data sets based on a group type of an input group corresponding to the respective training data set among the plurality of input groups.

11. The method of claim 10, wherein the differently training includes training the AI model using first user inputs and first inference results as ground truth data, the first inference results corresponding to the first user inputs, the first user inputs being among the plurality of user inputs, the first inference results being among the plurality of inference results, and the first user inputs being included in a first input group corresponding to the first group type among the plurality of input groups.

12. The method of claim 11, wherein the differently training includes training the AI model using second user inputs and second inference results to acquire improved data from the AI model trained using the ground truth data, the second inference results corresponding to the second user inputs, the second user inputs being among the plurality of user inputs, the second inference results being among the plurality of inference results, and the second user inputs being included in a second input group corresponding to the second group type among the plurality of input groups.

13. The method of claim 12, further comprising:
generating a plurality of improved inference results for agent invocation corresponding to a specific second user input among the second user inputs using the AI model trained using the ground truth data;
inputting the plurality of improved inference results to an agent and acquiring a plurality of agent performance results corresponding to each of the plurality of improved inference results from the agent;
determining a relevance of the plurality of agent performance results based on a user intent corresponding to the specific second user input; and
ranking the plurality of improved inference results based on the relevance.

14. The method of claim 1, wherein
each among the plurality of user inputs corresponds to a respective user query;
the agent includes a search system configured to perform a search for the respective user query;
each among the plurality of inference results corresponds to agent input data input to the agent to obtain a respective search result that aligns with a user intent; and
the AI model is a model configured to generate the agent input data corresponding to the respective user query.

15. The method of claim 1, further comprising:
forming training data sets respectively corresponding to different input groups among the plurality of input groups based on the specifying; and
training the AI model using the training data sets.

16. A system for building training data for Artificial Intelligence (AI) models, the system comprising:
a memory storing computer-readable instructions; and
at least one processor configured to execute the computer-readable instructions to cause the system to,
collect a plurality of user inputs input to a generative AI search system,
collect a plurality of inference results for agent invocation from an AI model configured to process each of the plurality of user inputs, each among the plurality of inference results corresponding to one among the plurality of user inputs,
determine a respective suitability of each among the plurality of inference results using at least some among the plurality of user inputs to obtain suitability determination results, and
specify a respective group type of each among a plurality of input groups using the suitability determination results, each among the plurality of input groups including at least some among the plurality of user inputs.

17. A method for building training data for Artificial Intelligence (AI) models, the method comprising:
collecting a plurality of performance results output from an agent of a generative AI search system;
collecting a plurality of first inference results from a first AI model that processes each of the plurality of performance results, each among the plurality of first inference results corresponding to one among the plurality of performance results, and the first AI model being among the AI models;
determining a respective suitability of each among the plurality of first inference results using at least some among the plurality of performance results to obtain suitability determination results; and
specifying a respective group type of each among a plurality of performance result groups using the suitability determination results, each among the plurality of performance result groups including at least some among the plurality of performance results.

18. The method of claim 17, wherein
the first AI model is a search query model configured to generate a search query corresponding to a user query; and
the agent is a search system configured to perform a search for the search query.

19. The method of claim 17, further comprising:
generating, using a second AI model among the AI models, a respective answer corresponding to each among the plurality of performance results as a second inference result based on the plurality of performance results being processed as input data.

20. The method of claim 19, further comprising:
forming training data sets respectively corresponding to different performance result groups among the plurality of performance result groups based on the specifying; and
training the second AI model using the training data sets.
